(19) United States
(12) Patent Application Publication
(10) Pub. No.: US 2016/0358220 A1
(43) Pub. Date: Dec. 8, 2016

(54) METHODS AND SYSTEMS FOR IDENTIFYING USERS FOR A MARKETING CAMPAIGN

(71) Applicant: XEROX CORPORATION, Norwalk, CT (US)

(72) Inventor: Saurabh Kataria, Rochester, NY (US)

(21) Appl. No.: 14/731,449

(22) Filed: Jun. 5, 2015

(51) Int. Cl. G06Q 30/02; G06Q 50/00

(52) U.S. Cl. CPC G06Q 30/0269; G06Q 30/0255; G06Q 50/01

(57) ABSTRACT

The disclosed embodiments illustrate methods and systems for identifying a set of users for a marketing campaign. The method includes retrieving one or more first keywords from one or more messages shared by one or more first users, or from a user profile of each of one or more first users. The one or more first keywords are indicative of one or more events associated with one or more first users, and one or more intents of said one or more first users. The method further includes receiving one or more second keywords, pertaining to marketing campaign, from a computing device of a second user. Thereafter, the method includes identifying said set of users from said one or more first users based on a correlation between said one or more first keywords and said one or more second keywords. The method is performed by one or more microprocessors.

### TECHNICAL FIELD

The presently disclosed embodiments are related, in general, to marketing products/services. More particularly, the presently disclosed embodiments are related to methods and systems for identifying a set of users for a marketing campaign.

### BACKGROUND

With the advancement in communication technology and the penetration of internet among the masses, various organizations/enterprises (e.g., retailers, marketers, brand managers, and salesforce) are increasingly leveraging one or more social media platforms for launching customer engagement/product promotion marketing campaigns. The one or more social media platforms may provide multi-channel communication mediums to such organizations/enterprises for communicating with target customers of their choice. For instance, a retailer might be interested in identifying customers on the one or more social media platforms, who have certain attributes (e.g., male working professionals in the age group of 20-32 years, possessing a vehicle for more than 3 years). The retailer may then communicate appropriate deals/marketing campaigns to these identified customers (e.g., a deal/offer for an entry-level sedan vehicle). To identify the relevant customers on the one or more social media platforms (such as Facebook™, LinkedIn™, Twitter™, and the like), various techniques known in the art may be used. For example, keywords based methods or classification based methods are some of the well-known techniques that may be used for identifying relevant customers on the one or more social media platforms.

### SUMMARY

According to the embodiments illustrated herein, there is provided a method for identifying a set of users for a marketing campaign. The method includes retrieving one or more first keywords from one or more of one or more messages shared by one or more first users, or from a user profile of each of said one or more first users. The one or more first keywords are indicative of one or more events associated with said one or more first users, and one or more intents of said one or more first users. The method further includes receiving one or more second keywords, pertaining to said marketing campaign, from a computing device of a second user. Thereafter, the method includes identifying said set of users from said one or more first users based on a correlation between said one or more first keywords and said one or more second keywords. The method is performed by one or more microprocessors.

According to the embodiments illustrated herein, there is provided a system for identifying a set of users for a marketing campaign. The system includes one or more microprocessors configured to retrieve one or more first keywords from one or more of one or more messages shared by one or more first users, or from a user profile of each of said one or more first users. The one or more first keywords are indicative of one or more events associated with said one or more first users, and one or more intents of said one or more first users. The system further includes one or more microprocessors configured to receive one or more second keywords, pertaining to said marketing campaign, from a computing device of a second user. Thereafter, the system includes one or more microprocessors configured to identify said set of users from said one or more first users based on a correlation between said one or more first keywords and said one or more second keywords.

According to the embodiments illustrated herein, there is provided a computer program product for use with a computing device. The computer program product comprises a non-transitory computer readable medium, the non-transitory computer readable medium stores a computer program code for identifying a set of users for a marketing campaign. The computer program code is executable by one or more microprocessors to retrieve one or more first keywords from one or more of one or more messages shared by one or more first users, or from a user profile of each of said one or more first users. The one or more first keywords are indicative of one or more events associated with said one or more first users, and one or more intents of said one or more first users. The computer program code is further executable by one or more microprocessors to receive one or more second keywords, pertaining to said marketing campaign, a computing device of a second user. Thereafter, the computer program code is further executable by one or more microprocessors to identify said set of users from said one or more first users based on a correlation between said one or more first keywords and said one or more second keywords.

### BRIEF DESCRIPTION OF DRAWINGS

The accompanying drawings illustrate the various embodiments of systems, methods, and other aspects of the disclosure. Any person with ordinary skill in the art would appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram illustrating a system environment in which various embodiments may be implemented;

FIGS. 2A and 2B is a block diagram illustrating functional relationships between components of the system environment, in accordance with at least one embodiment;

FIG. 3 is a block diagram illustrating a system for identifying a set of users for a marketing campaign, in accordance with at least one embodiment;

FIG. 4 is a flowchart illustrating a method for identifying a set of users for a marketing campaign, in accordance with at least one embodiment; and

FIGS. 5A, 5B, 5C, 5D, and 5E illustrate an example graphical user interface presented to a second user, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on, indicate that the embodiment(s) or example(s) may include a particular feature, structure, characteristic, property, element, or limitation, but that not every embodiment or example necessarily includes that particular feature, structure, characteristic, property, element, or limitation. Further, repeated use of the phrase “in an embodiment” does not necessarily refer to the same embodiment.

### DEFINITIONS

The following terms shall have, for the purposes of this application, the meanings set forth below.

A “social media platform” refers to a communication medium through which a user may interact with one or more other users who are known to or otherwise acquainted with the user. Further, apart from interacting with one another, the user and the one or more other users may post/share one or more messages on the social media platform. Thereafter, one or more users may interact with one another in reference to the one or more messages. Examples of social media platform include, but are not limited to, social networking websites (e.g., Facebook™, Twitter™, LinkedIn™ Google+™, and so forth), web-blogs, web-forums, community portals, online communities, or online interest groups.

“One or more first users” refer to individuals who may be members of one or more social media platforms. In an embodiment, the one or more first users may have registered on the one or more social media platforms to become members/users of the social media platforms. During registration, the one or more first users may have provided various information such as, but not limited to, a name, a gender, a location, an age, an education, a profession, one or more images, interests/hobbies, and so forth. In an embodiment, the one or more first users may share/post one or more messages on the one or more social media platforms.

“One or more messages” refer to information communicated between two or more individuals or groups of individuals with respect to a particular topic. In an embodiment, the individuals may correspond to one or more first users. In an embodiment, one or more first users may post/share the one or more messages related to a topic of interest on one or more social media platforms. In an embodiment, the one or more messages may include different types of messages such as an audio message, a video message, a text message, or a combination thereof.

“An event” refers to phenomena that may be of significance to a first user. Further, the event may occur at a predetermined time at a predetermined location and may involve the first user. In an embodiment, events may be classified as a first set of events and a second set of events. In an embodiment, the first set of events may correspond to events involving the first user. On the other hand, the second set of events may correspond to events involving other first users (from the one or more first users) acquainted to the first user on one or more social media platforms. Further, the one or more events may relate to a topic of interest. Examples of an event include, but are not limited to, a seasonal event, a personal event, a public event, a business event, or a sports event.

“One or more intents” refer to one or more interests of one or more first users to purchase one or more products/services. For example, if there is a birth of a child in a family of a user, then there is a possibility that the user may show an intent to purchase a vehicle. In another scenario, if a user likes a particular brand, such as “NIKE”, then the user may show an interest in purchasing products/services pertaining to the brand “NIKE”.

“One or more first keywords” refer to words, letters, phrases, sentences, and the like, that correspond to at least one of one or more messages shared by one or more first users, or a user profile of each of the one or more first users. In an embodiment, the one or more first keywords may indicate one or more events associated with the one or more first users. In an embodiment, the one or more first keywords may indicate one or more intents (e.g., purchasing one or more products/services) of the one or more first users. For example, if a user wants to buy a car, then the keywords “buy” and “car” may indicate an intent of the user to buy a car.

A “second user” refers to an individual who may provide one or more second keywords pertaining to a marketing campaign. In an embodiment, the second user may correspond to a retailer, a marketer, or a retail vendor. In an embodiment, the second user may receive a list of a second set of users through a graphical user interface.

A “marketing campaign” refers to a set of initiatives undertaken by a second user associated with an enterprise/organization to expand/consolidate the enterprise/organization's business by reaching out to its customers/potential customers with lucrative deals/offers. In an embodiment, the marketing campaign may correspond to a promotion of products/services through different mediums such as television, radio, print, or online. In an embodiment, the marketing campaign may include one or more second keywords. In an embodiment, the marketing campaign may be updated based on a feedback received from a second set of users. The marketing campaign may correspond to at least an advertising marketing campaign, an organizational marketing campaign, or a political marketing campaign.

“One or more second keywords” refer to words, letters, phrases, sentences, and the like, that may be provided by a second user. In an embodiment, the one or more second keywords may correspond to a marketing campaign. In an embodiment, the one or more second keywords may correspond to a target event, target intent, or a combination thereof. For example, the target events may include marriage, graduation, job, etc., target intent may correspond to an intent to purchase one or more products/services.

A “set of users” refer to one or more users that may be identified from the one or more first users. In an embodiment, the set of users may be identified based on a correlation between one or more first keywords and one or more second keywords.

A “user profile” refers to a profile associated with one or more first users that includes demographic information. For example, the user profile may include, but is not limited to, a location of a user, a gender of the user, a marital status of the user, an ethnicity of the user, a nationality of the user, a mother tongue of the user, an educational qualification of the user, a set of hobbies of the user, and an age of the user.

“One or more sets of categories” refer to one or more categories into which the set of users may be classified using one or more classifiers. In an embodiment, the one or more sets of categories may include, but are not limited to, demographic categories, one or more products/services owned/availed by the set of users, a rating provided by the set of users on the one or more products/services, one or more events associated with each user in the set of users, and an intent to purchase the one or more products or services.

A “classifier” refers to a mathematical model that may be configured to categorize a user (or a set of users) in one of the categories from the set of categories. In an embodiment, each classifier may be trained for a particular set of category from the one or more sets of categories. For example, a first classifier may be trained for a set of demographic categories. Further, a second classifier may be trained for a set of events categories, and so on. Thus, the first classifier may be used to classify the user (or the set of users) in a demographic category from the set of demographic categories. Similarly, the second classifier may be used to classify the user (or the set of users) in an events category from the set of events categories, and so on.

A “score” refers to value determined for each of the one or more classifiers. In an embodiment, the score may indicate a confidence measure of each of the one or more classifiers in classifying the set of users in the one or more sets of categories. In an embodiment, the score may be determined by using at least a regression model. Examples of the regression model may include, but are not limited to, a linear regression, a simple regression, a polynomial regression, or a logistic regression, and so on.

“Second user's preferences” refer to one or more preferences that may be defined by a second user to identify the second set of users from the set of users. In an embodiment, the second user's preferences may include, but are not limited to, selecting a user from the second set of users for the marketing campaign, or selecting a set of categories from the one or more sets of categories for the marketing campaign.

A “second set of users” refer to users that may be identified from the set of users. In an embodiment, the second set of users may be identified based at least on a set of rules defined for each of the one or more sets of categories, the score, or the second user's preferences. In an embodiment, the second set of users may receive the marketing campaign from the second user. The set of rules may comprise demographics/group rules, an event oriented rules, and an intent oriented rules. In an embodiment, a list of the second set of users may be displayed through a graphical user interface to the second user.

Graphical User Interface OR “GUI” refers to an interface that facilitates a user to interact with associated computing devices. The user can interact with the GUI using various input mediums/techniques including, but not limited to, a keypad, a mouse, a joystick, any touch-sensitive medium (e.g., a touch-screen or touch sensitive pad), a voice recognition system, gesture recognition system, and so forth. In an embodiment, the GUI may act as an interface for the second user to create a marketing campaign, by specifying the one or more second keywords. Further, the GUI may display a list of the second set of users to the second user for the marketing campaign. In an embodiment, the GUI may act as an interface for the second user to create a group of identified second set of users. Thereafter, the second user may use the graphical user interface to send the marketing campaign to the group of identified second set of users on their respective computing devices.

“Feedback” refers to an input provided by second set of users on the marketing campaign. In an embodiment, the feedback may correspond to one or more actions performed by the second set of users on the marketing campaign. In an embodiment, the one or more actions may include, but are not limited to, sharing the marketing campaign, commenting on the marketing campaign, liking/disliking the marketing campaign, posting comments associated with the marketing campaign, uploading/downloading content associated with the marketing campaign, and so on.

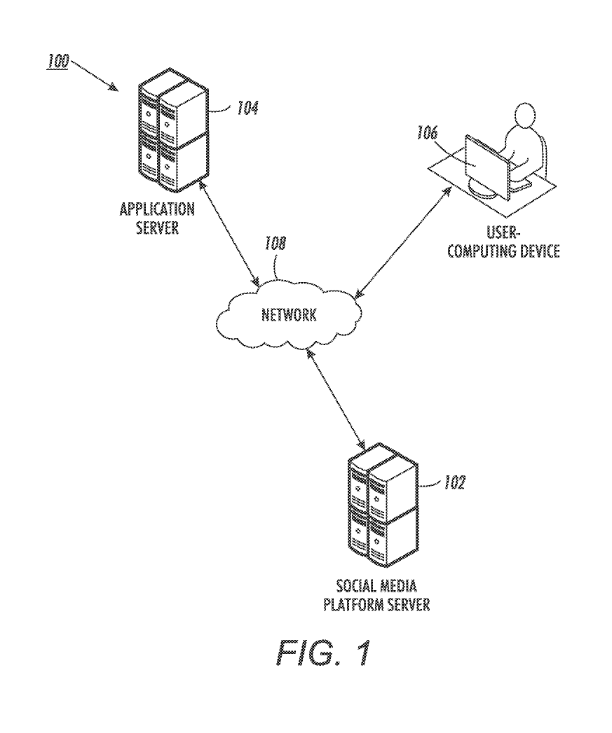

FIG. 1 is a block diagram of a system environment 100, in which various embodiments can be implemented. The system environment 100 includes a social media platform server 102, an application server 104, a user-computing device 106, and a network 108. Various devices in the system environment 100 (e.g., the social media platform server 102, an application server 104, and a user-computing device 106) may be interconnected over the network 108.

The social media platform server 102 may refer to a computing device that may include a processor, a memory, and other hardware devices. The social media platform server 102 is configured to host one or more social media platforms such as, but not limited to, a social networking website, a chat/messaging application, a web-blog, web-forums, a community portal, an online community, or an online interest group. In an embodiment, one or more first users may register on the one or more social media platforms. Further, each of the one or more first users, while registering onto the one or more social media platforms, may create a user profile. After registration, the one or more first users may post/share one or more messages on the one or more social media platforms. The one or more messages may include one or more types of messages such as, but not limited to, an audio message, a video message, or a text message. In an embodiment, the social media platform server 102 may store the one or more messages in its memory. In an embodiment, the social media platform server 102 may be realized through various web-based technologies such as, but not limited to, a Java web-framework, a .NET framework, a PHP framework, or any other web-application framework.

The application server 104 may refer to a computing device configured to identify a set of users for a marketing campaign. In an embodiment, the application server 104 includes one or more processors, and one or more memories coupled to the one or more processors. The one or more memories are used to store instructions that are executable by the one or more processors to perform predetermined operations. In an embodiment, the application server 104 may extract one or more messages from one or more social media platforms. The one or more messages may include one or more types of messages such as, an audio message, a video message, or a text message. Thereafter, the application server 104 may retrieve one or more first keywords from the one or more messages shared by the one or more first users on the one or more social media platforms. In an embodiment, the application server 104 may further extract the one or more first keywords from the user profile of each of the one or more first users. The one or more first keywords may indicate one or more events associated with the one or more first users, and/or one or more intents of the one or more first users. In an embodiment, the one or more first keywords may be stored in the memory (not shown) of the application server 104. Further, the application server 104 may receive one or more second keywords, pertaining to the marketing campaign from a second user (through the user-computing device 106). In an embodiment, the application server 104 may identify the set of users from the one or more first users based on a correlation between the one or more first keywords and the one or more second keywords. Further, the application server 104 may classify the identified set of users in one or more sets of categories using one or more classifiers. In an embodiment, each of the one or more classifiers may be configured for classifying users in a set of categories from the one or more sets of categories. In an embodiment, the application server 104 may store the information related to classification of set of users in the one or more sets of categories in its memory (not shown). In an embodiment, the application server 104 may determine a score for each of the one or more classifiers. In an embodiment, the application server 104 may receive a set of rules from the second user of the user-computing device 106. Further, the application server 104 may identify a second set of users from the set of users based at least on the set of rules defined for each of the one or more sets of categories, the score, or the second user's preferences. Thereafter, the application server 104 may send the marketing campaign to the identified second set of users.

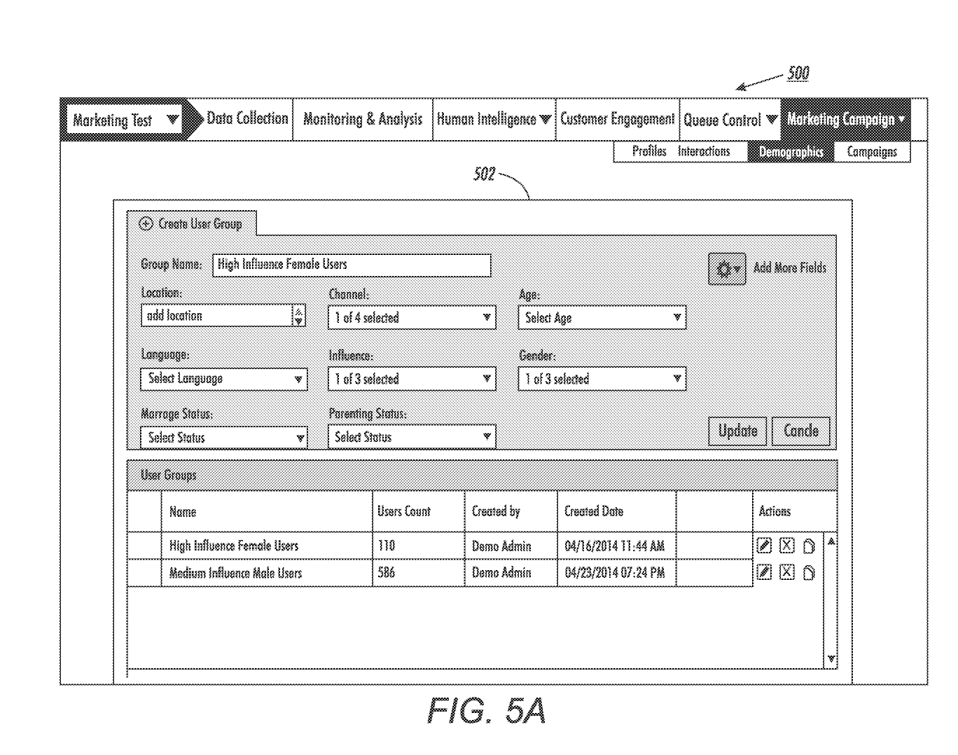

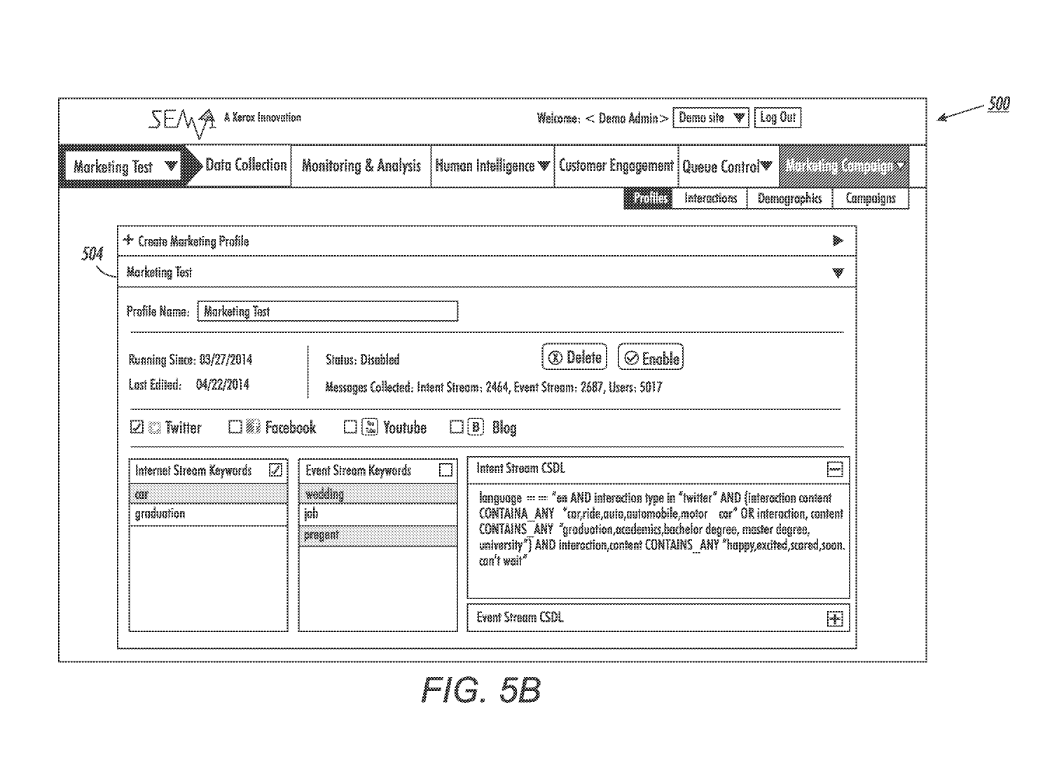

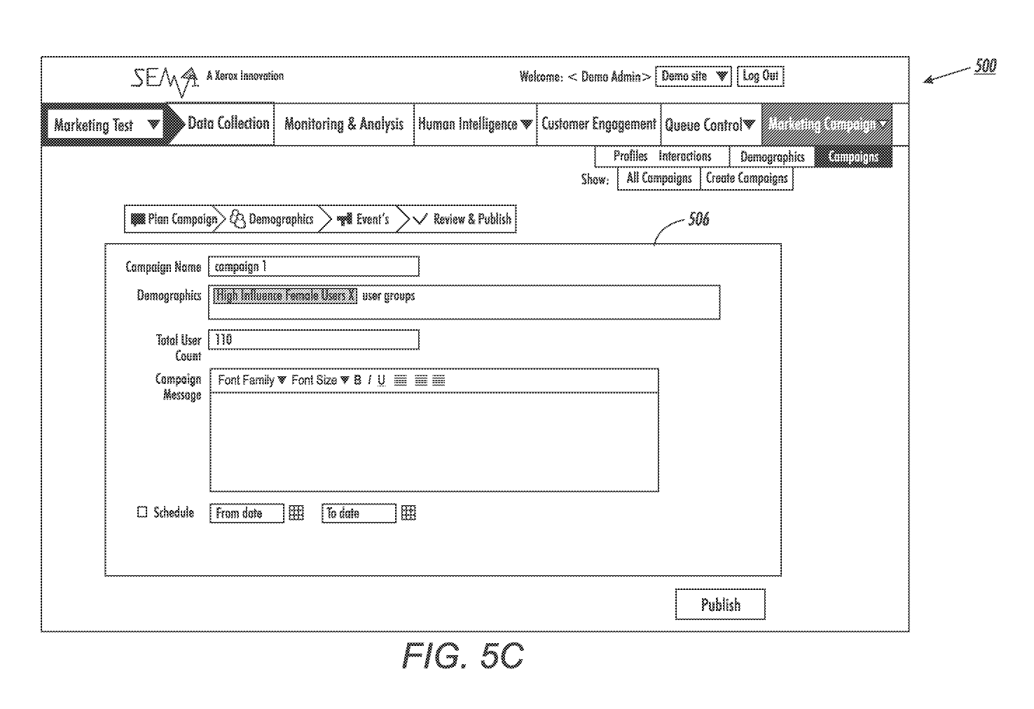

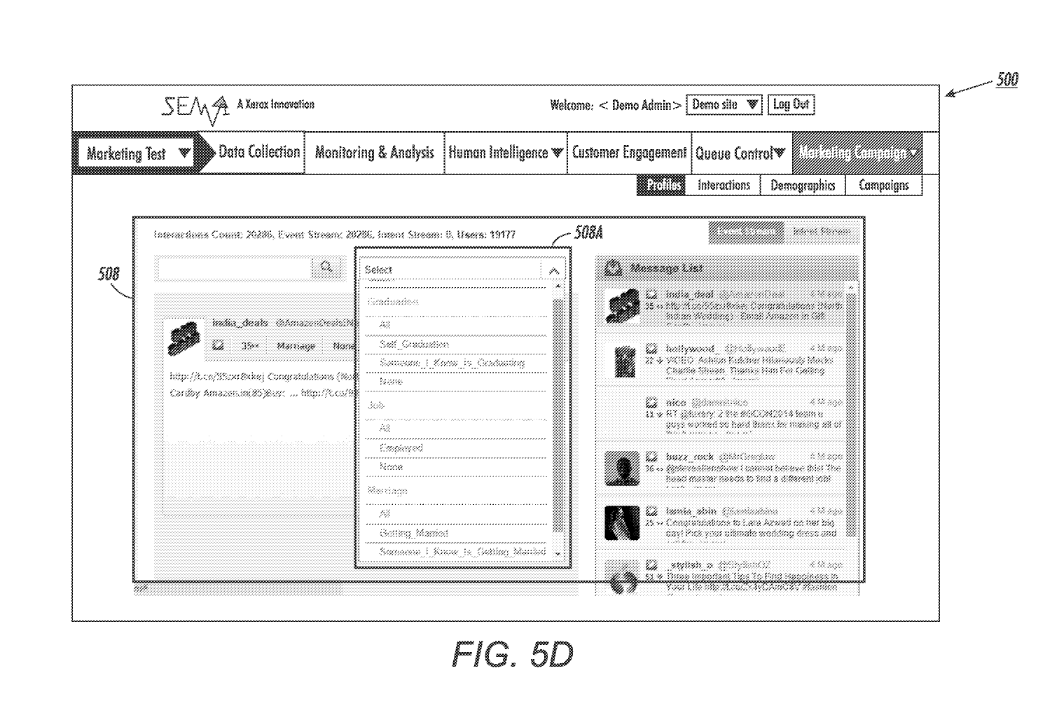

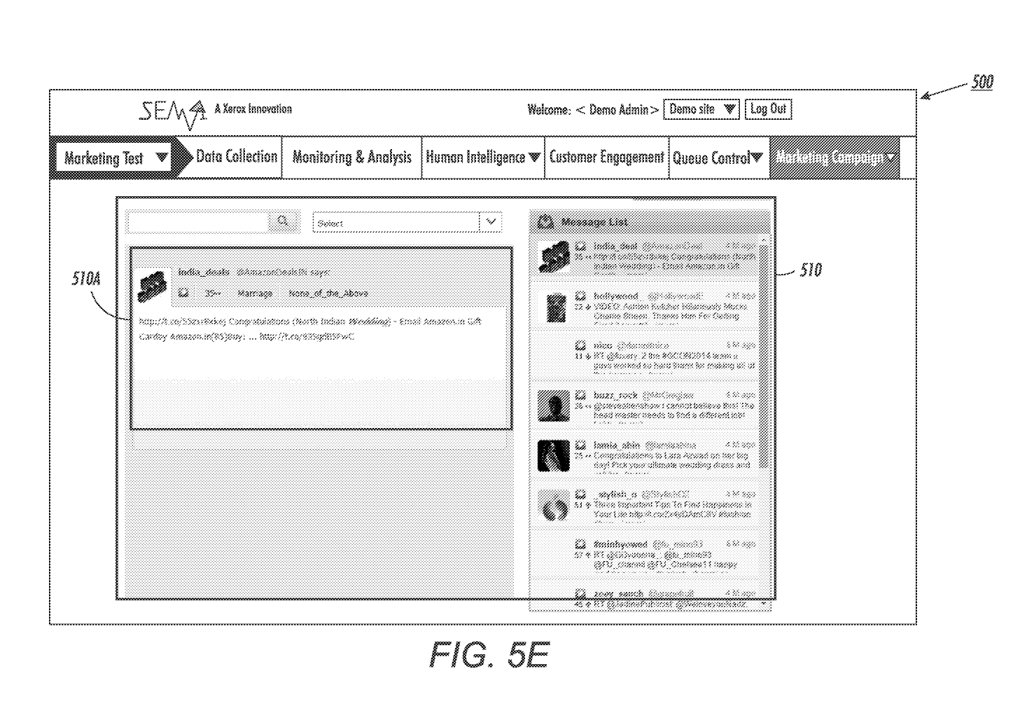

In an embodiment, the application server 104 may present a graphical user interface to the second user through the user-computing device 106. The graphical user interface (GUI) may be utilized for displaying a list of the second set of users to the second user. The graphical user interface has been further described later in conjunction with the FIGS. 5A, 5B, 5C, 5D, and 5E.

Further, the application server 104 may receive a feedback from the second set of users on the marketing campaign. The feedback may correspond to one or more actions performed by the second set of users on the marketing campaign. In an embodiment, the one or more actions performed by the second set of users may include, but are not limited to, sharing the marketing campaign, commenting about the marketing campaign, liking/disliking the marketing campaign, posting content associated with the marketing campaign, or uploading/downloading content associated with the marketing campaign, and so on. Based on the received feedback, the application server 104 may update the marketing campaign.

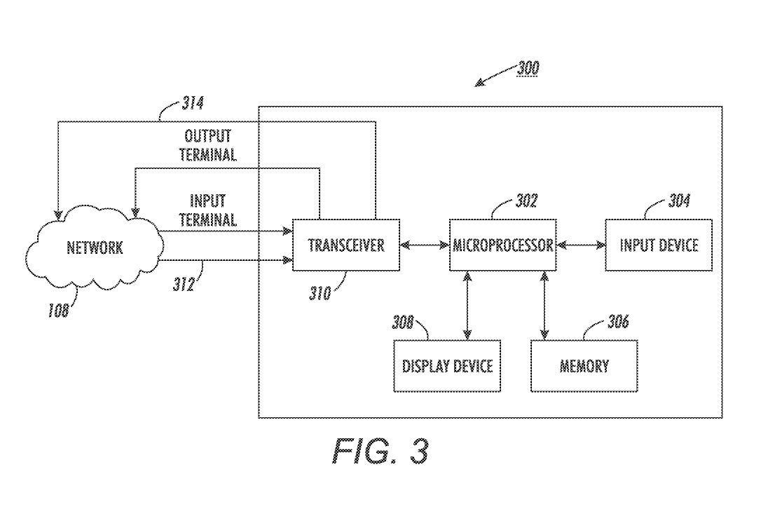

The application server 104 may be realized using various technologies such as, but not limited to, Java application server, .NET Framework, PHP, Base4 application server, and Appaserver. The application server 104 has been described later in conjunction with FIG. 3.

The user-computing device 106 may refer to a computing device used by a second user to define a marketing campaign. The user-computing device 106 may include one or more processors, and one or more memories that are used to store instructions. These instructions are executable by the one or more processors to perform a predetermined operation. In an embodiment, the user-computing device 106 may be communicatively coupled to the network 108. In an embodiment, the user-computing device 106 may have a coupled input device that may be configured to receive the one or more second keywords pertaining to the marketing campaign from the second user of the user-computing device 106. In an embodiment, the input device may correspond to a keyboard, a mouse, or a touch screen. In an embodiment, the one or more second keywords may indicate one or more events (e.g., marriage, graduation, job, etc.), one or more intents (e.g., purchasing one or more products/services), or a combination thereof. The marketing campaign may correspond to an advertising marketing campaign, an organizational marketing campaign, or a political marketing campaign. In an embodiment, the one or more second keywords and the marketing campaign may be stored in the memory (not shown) of the user-computing device 106.

In an embodiment, the second user of the user-computing device 106 may provide input on the input device of the user-computing device 106 to access the application server 104. Further, the application server 104 (on receiving input from the user-computing device 106) may retrieve a graphical user interface (GUI) related information from the memory (not shown) of the application server 104. The user-computing device 106 may receive the GUI related information from the application server 104 and render a GUI based on the GUI related information. In an embodiment, the second user of the user-computing device 106 may define a set of rules for each of the one or more sets of categories through the GUI. The set of rules may correspond to demographics/group oriented rules, an event oriented rules, and an intent oriented rules. In an embodiment, the second user of the user-computing device 106 may provide one or more preferences through the GUI. The one or more preferences may include, but are not limited to, selecting a user from the second set of users for the marketing campaign, or selecting a set of categories from the one or more sets of categories for the marketing campaign. In an embodiment, the one or more preferences may be stored in the memory (not shown) of the user-computing device 106. Based on the set of rules and the one or more preferences, the second user of the user-computing device 106 may receive a list of second set of users through the GUI. In an embodiment, the list of second set of users may be stored in the memory (not shown) of the user-computing device 106.

In an embodiment, the second user may utilize the user-computing device 106 to transmit or receive information pertaining to one or more first users to/from the social media platform server 102, and/or the application server 104 over the network 108. For example, the second user may transmit, using the user-computing device 106, one or more second keywords pertaining to the marketing campaign to the application server 104.

The user-computing device 106 may correspond to various types of computing devices such as, but not limited to, a desktop computer, a laptop, a personal digital assistant (PDA), a mobile device, a smartphone, a tablet computer (e.g., iPad® and Samsung Galaxy Tab®), and the like.

In an embodiment, the second user may correspond to, but is not limited to, a retailer, a marketer, or a retail vendor, who may want to identify the set of users for the marketing campaign.

A person skilled in the art will appreciate that the scope of the disclosure is not limited to the application server 104 and the user-computing device 106 being separate entities. In an embodiment, the application server 104 may correspond to an application hosted on or running on the user-computing device 106 without departing from the spirit of the disclosure.

The network 108 corresponds to a medium through which content and messages flow between various devices of the system environment 100 (e.g., the social media platform server 102, the application server 104, and the user-computing device 106). Examples of the network 108 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 108 in accordance with various wired and wireless communication protocols such as Transmission Control Protocol and Internet Protocol (TCP/IP), User Datagram Protocol (UDP), and 2G, 3G, or 4G communication protocols.

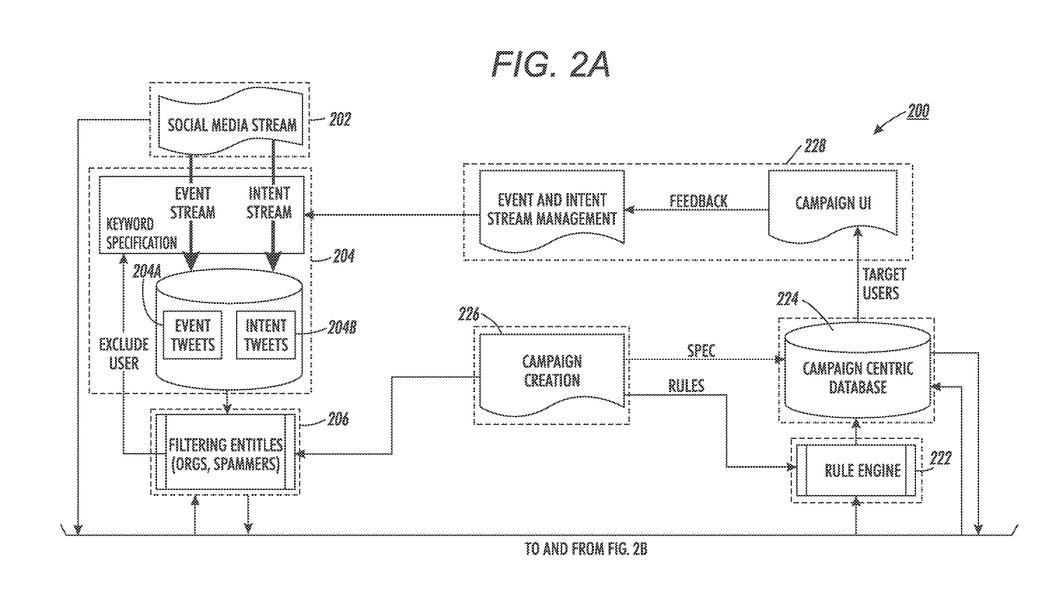

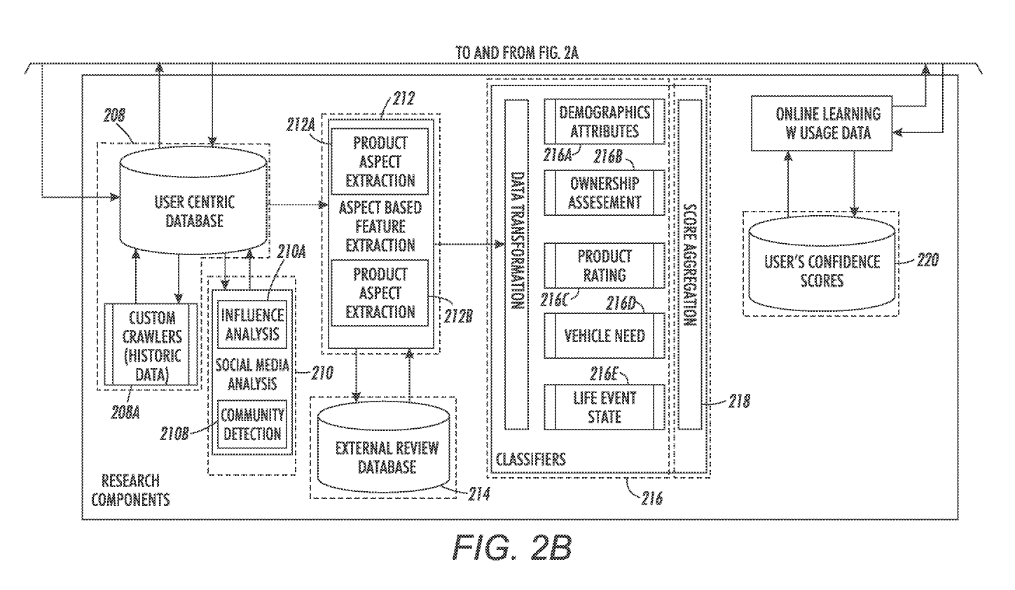

FIGS. 2A and 2B is a block diagram 200 illustrating functional relationships between components of the system environment 100, in accordance with at least one embodiment. As discussed above, the system environment 100 includes the social media platform server 102, the application server 104, and the user-computing device 106.

The social media platform server 102 includes a social media stream module 202.

The application server 104 includes a keyword specification module 204, a filtering module 206, a user database 208, a social media analysis module 210, a feature extraction module 212, a review database 214, a classification module 216, a scoring module 218, a score database 220, and a rule engine module 222.

The user-computing device 106 includes a marketing campaign database 224, a marketing campaign creation module 226, and a UI module 228.

The social media stream module 202, in the social media platform server 102, is a set of computer readable instructions, which when executed by a processor of the social media platform server 102, may be utilized to analyze social media stream. The social media stream may include the one or more messages posted/shared by one or more first users on one or more social media platforms. Prior to posting/sharing the one or more messages, the one or more first users may register on the one or more social media platforms. Examples of the one or more social media platforms include, but are not limited to, a social networking website, a chat/messaging application, a web-blog, web-forums, a community portal, an online community, or an online interest group. Further, each of the one or more first users, while registering onto the one or more social media platforms, may create a user profile. After registration, the one or more first users may post/share the one or more messages on the one or more social media platforms. In an embodiment, the social media platform server 102 may store the one or more messages in the user database 208. In an embodiment, the one or more messages may include one or more types of messages such as, but not limited to, an audio message, a video message, or a text message. In an embodiment, the social media platform server 102 may store the user profile of the one or more first users in the user database 208.

The keyword specification module 204, in the application server 104, is a set of computer readable instructions, which when executed by a processor of the application server 104, may be utilized to extract one or more first keywords from the one or more messages posted/shared by the one or more first users on the one or more social media platforms. In an embodiment, the keyword specification module 204 may analyze the social media stream to obtain the one or more messages. In an embodiment, the keyword specification module 204 may further extract the one or more first keywords from the user profile of each of the one or more first users. In an embodiment, the one or more first keywords may indicate the one or more events associated with the one or more first users. In an embodiment, the one or more events may be categorized into a first set of events and a second set of events. In an embodiment, the first set of events may include events in life of the one or more first users. On the other hand, the second set of events may include events in the life of one or more third users (i.e., other user's life), acquainted with the one or more first users. In another embodiment, the one or more first keywords may further indicate one or more intents of the one or more first users. In an embodiment, the keyword specification module 204 may store the one or more first keywords in the user database 208. In an embodiment, the keyword specification module 204 may categorize the one or more first keywords based on the events (i.e., an event stream) and the intents (i.e., an intent stream) associated with the one or more first users. In an embodiment, an event stream may include a first set of keywords (e.g., event tweets 204a), from the one or more first keywords, which correspond to a particular event. On the other hand, an intent stream may include a second set of keywords (e.g., intent tweets 204b), from the one or more first keywords, which correspond to a particular intent.

In an embodiment, the keyword specification module 204 may further receive a feedback, pertaining to a marketing campaign from computing devices of the second set of users (to whom the marketing campaign was sent). The keyword specification module 204 may utilize the feedback for defining more keywords for the marketing campaign.

The filtering module 206, in the application server 104, is a set of computer readable instructions, which when executed by the processor of the application server 104, may be utilized to identify a set of users from the one or more first users. In an embodiment, the filtering module 206 may extract the one or more first keywords from the user database 208. Further, the filtering module 206 may receive the one or more second keywords from the user-computing device 106. Thereafter, the filtering module 206 may determine a correlation between the one or more first keywords and the one or more second keywords. Based on the correlation between the one or more first keywords and the one or more second keywords, the filtering module 206 may identify keywords from the one or more first keywords. Further, based on the identified keywords, the filtering module 206 may filter a set of users from the one or more first users. In an embodiment, the set of users may have utilized the identified keywords in the one or more messages posted/shared by them on the one or more social media platforms. Further, the filtering module 206 may receive information pertaining to the one or more first users from the user database 208. In an embodiment, the filtering module 206 may store a list of identified set of users in the user database 208.

The user database 208 may be utilized to store the information pertaining to the one or more first users. The information pertaining to the one or more first users may correspond to the user profile of each of the one or more first users. The user profile of each of the one or more first users may include information such as, but not limited to, a location of a user, a gender of the user, a marital status of the user, an ethnicity of the user, a nationality of the user, a mother tongue of the user, an educational qualification of the user, a set of hobbies of the user, and an age of the user. Further, the user database 208 may store the one or more messages posted/shared by the one or more first users on the one or more social media platforms. In an embodiment, the user database 208 may store the one or more first keywords retrieved from at least the one or more messages shared by the one or more first users, or from the user profile of each of the one or more first users. The one or more first keywords may indicate the one or more events associated with the one or more first users and the one or more intents of the one or more first users. The user database 208 may further include a sub-module i.e. a historical data module 208a. The historical data module 208a may utilize a query application programming interface or a social media streaming interface (e.g., twitter streaming, Facebook streaming, etc.) to obtain the one or more messages. For instance, the one or more messages may correspond to tweets posted by the one or more first users on the social networking sites.

In an embodiment, the user database 208 may send the information pertaining to the one or more first users to the feature extraction module 212. In an embodiment, the user database 208 may further interact with the social media analysis module 210 to detect communities of users based on the detected one or more events and the one or more intents. In another embodiment, the user database 208 may further store the list of identified set of users (received from the filtering module 206). In an embodiment, the user database 208 may be realized through various technologies such as, but not limited to, Microsoft® SQL Server, Oracle™, and My SQL™.

The social media analysis module 210, in the application server 104, is a set of computer readable instructions, which when executed by the processor of the application server 104, may be utilized to detect the influence of the users and the communities of the users around the detected events and intents. The social media analysis module 210 may further include two sub-modules i.e. an influence analysis module 210a and a community detection module 210b. The influence analysis module 210a may be utilized to determine how other individuals influence users in the social media network based upon the detected events and intents. For example, the colleagues have strong influence on one's work, while the friends have strong influence on one's daily life, etc. On the other hand, the community detection module 210b may be utilized to detect communities of users around the detected events and intents. In an embodiment, the communities of users may be detected based on a common interest of the users. For example, if the detected intent of the user corresponds to buying branded accessories, then the community detection module 210b may detect those users who have a similar interest. In an embodiment, the communities of users may include, but are not limited to, online research communities, art communities, political communities, blogging communities, and so on.

The feature extraction module 212, in the application server 104 has one or more computer readable instructions that are executable by the processor of the application server 104 to extract features of one or more products/services and to determine sentiments of the users on the extracted features of the one or more products/services. Further, the feature extraction module 212 includes two sub-modules, i.e., a product aspect extraction module 212a and a user sentiment analysis module 212b. In an embodiment, the product aspect extraction module 212a may be utilized to extract features of the one or more products/services. The features of the one or more products/services may correspond to name of a brand, etc. On the other hand, the user sentiment analysis module 212b may be utilized to determine sentiments of the users on the extracted features of the one or more products/services. In an embodiment, the sentiments of the users may correspond to a liking/disliking of the user for the one or more products/services or a brand associated with the one or more products/services. In an embodiment, the feature extraction module 212 may further store the extracted features in the review database 214. Further, the feature extraction module 212 may send the extracted features of the one or more products/services and the sentiments of the users on the extracted features of the one or more products/services to the classification module 216.

The review database 214 may be utilized to store the extracted features of the one or more products/services (received from the feature extraction module 212). In an embodiment, the review database 214 may be further utilized to store the user's sentiment on the one or more products/services (received from the feature extraction module 212).

The classification module 216, in the application server 104, is a set of computer readable instructions, which when executed by the processor of the application server 104, may be utilized to classify the identified set of users in the one or more sets of categories (depicted by 216a, 216b, 216c, 216d, and 216e) using one or more classifiers. In an embodiment, each of the one or more classifiers may be configured to classify the set of users in a set of categories from the one or more sets of categories. In an embodiment, the classification module 216 may extract the list of identified set of users from the user database 208. Thereafter, the classification module 216 may classify the identified set of users in the one or more sets of categories. The one or more sets of categories may include, but are not limited to, demographic categories (depicted by 216a), one or more products/services owned/availed by set of users (depicted by 216b), a rating provided by the set of users on the one or more products/services (depicted by 216c), an intent to purchase the one or more products/services (depicted by 216d), and one or more events associated with each user in the set of users (depicted by 216e).

In an embodiment, the demographic categories 216a may include information such as, but not limited to, a location of a user, a gender of the user, an income of the user, a marital status of the user, an ethnicity of the user, a nationality of the user, a mother tongue of the user, an educational qualification of the user, a set of hobbies of the user, or an age of the user. In an embodiment, the demographic information may be utilized by the second user of the user-computing device 106 to create a group of the identified set of users.

Further, the one or more products/services owned/availed by the set of users category 216b may include information that correspond to one or more products/services availed by the set of users. The information may correspond to whether a user owns a vehicle or not, whether a user likes a particular band “NIKE” or not, etc.

The rating provided by the set of users on the one or more products/services category 216c may include information such as a feedback provided by the set of users on the one or more products/services. The feedback may correspond to liking/disliking, commenting, rating, etc., provided by the set of users on the one or more products/services.

The intent to purchase the one or more products/services category 216d may include information that correspond to an interest of the users in buying/purchasing a particular product/service. For example, if a user does not own a car, then the user may be interested in buying the car. In another scenario, if the user likes a particular brand “NIKE”, then the user may be interested in buying the t-shirts pertaining to the brand.

The one or more events associated with each user in the set of users category 216e may include information pertaining to the events in the user's life. For example, a user may be getting married, having a kid, graduating, or having a birthday.

Further, apart from classifying the set of users in one or more sets of categories, the classification module 216 may communicate with the scoring module 218 to determine the score for each of the one or more classifiers in classifying the set of users in the one or more sets of categories.

The scoring module 218, in the application server, is a set of computer readable instructions, which when executed by the processor of the application server 104, may be utilized to determine a score for each of the one or more classifiers. In an embodiment, the scoring module 218 may receive the classified set of users from the classification module 216. In an embodiment, the score may indicate a confidence measure of each of the one or more classifiers in classifying the set of users in the one or more sets of categories, as discussed above. Further, the scoring module 218 may store the score for each of the one or more classifiers in the score database 220.

The score database 220 may be utilized to store the determined score for each of the one or more classifiers (received from the scoring module 218). In an embodiment, the score database 220 may store the score that indicates a confidence measure of each of the one or more classifiers in classifying the set of users in the one or more sets of categories. In an embodiment, the rule engine module 222 may communicate with the score database 220.

The rule engine module 222, in the application server 104, is a set of computer readable instructions, which when executed by the processor of the application server 104, may be utilized to define a set of rules for the one or more sets of categories. In an embodiment, the rule engine module 222 may receive the set of rules from the marketing campaign creation module 226. The set of rules may correspond to a demographics/group oriented rules, an event oriented rules, and an intent oriented rules. The demographics/group oriented rules may correspond to selecting users having a certain type of demographic information such as a location of the user, a gender of the user, marital status of the user, and so on. Further, the event oriented rules may correspond to two different types of events such as the first set of events (i.e., direct events) and the second set of events (i.e., indirect events), as discussed above. Further, the intent oriented rules may correspond to selecting users who have expressed an explicit or implicit interest in purchasing the one or more products/services. For example, an interest of a user may include the user's wish to buy a vehicle. In an embodiment, the rule engine module 222 may communicate with the marketing campaign database 224 for storing the set of rules for the one or more sets of categories.

The marketing campaign database 224, in the user-computing device 106 may be utilized to store the information pertaining to the marketing campaign. In an embodiment, the marketing campaign database 224 may receive the information pertaining to the marketing campaign from the marketing campaign creation module 226. The information pertaining to the marketing campaign may include one or more second keywords pertaining to the marketing campaign (received from the second user of the user-computing device 106). In an embodiment, the one or more second keywords may correspond to the one or more events (e.g., marriage, graduation, job, etc.) and the one or more intents (an intent to purchase one or more products/services). In an embodiment, the marketing campaign database 224 may store the set of rules defined for each of the one or more sets of categories (received from the rule engine module 222). In an embodiment, the marketing campaign database 224 may further store a feedback received from the identified second set of users on the marketing campaign. Further, in an embodiment, the marketing campaign database 224 may store the updated marketing campaign (received from the marketing campaign creation module 226). In an embodiment, the marketing campaign database 224 may send the updated marketing campaign to the UI module 228.

The marketing campaign creation module 226, in the user-computing device 106, is a set of computer readable instructions, which when executed by a processor of the user-computing device 106, may be utilized by the second user to create a marketing campaign. The marketing campaign may be generated based on the one or more second keywords. In an embodiment, the one or more second keywords may correspond to the one or more events or the one or more intents. For example, the one or more second keywords may correspond to a marriage, a graduation, a job, etc. Further, the marketing campaign creation module 226 may store the created marketing campaign in the marketing campaign database 224. In an embodiment, the marketing campaign creation module 226 may extract the feedback from the marketing campaign database 224 to update the created marketing campaign. Thereafter, the marketing campaign creation module 226 may store the updated marketing campaign in the marketing campaign database 224.

In an embodiment, the marketing campaign creation module 226 may define the set of rules for each of the one or more sets of categories. Thereafter, the marketing campaign creation module 226 may transmit the set of rules to the rule engine module 222.

The UI module 228, in the user-computing device 106, is a set of computer readable instructions, which when executed by the processor of the user-computing device 106, may render a GUI based on the graphical user interface related information (received from the application server 104). In an embodiment, the UI module 228 may display a list of identified second set of users through the GUI to the second user. In an embodiment, the second user may provide one or more preferences through the GUI. The one or more preferences may correspond to selecting a user from the second set of users for the marketing campaign, or selecting a set of categories from the one or more sets of categories for the marketing campaign. Further, the UI module 228 extracts the marketing campaign from the marketing campaign database 224. Thereafter, the UI module 228 may send the marketing campaign to the identified second set of users. In an embodiment, the marketing campaign may correspond to an advertising marketing campaign, an organizational marketing campaign, or a political marketing campaign.

In an embodiment, the UI module 228 may receive the feedback from the second set of users on the marketing campaign. In an embodiment, the feedback may correspond to one or more actions performed by the second set of users on the marketing campaign. The one or more actions performed by the second set of users may include, but not limited to sharing the marketing campaign, commenting on the marketing campaign, liking/disliking the marketing campaign, posting content associated with the marketing campaign, uploading/downloading content associated with the marketing campaign, etc. In an embodiment, the UI module 228 may store the feedback in the marketing campaign database 224. Further, the UI module 228 may extract the updated marketing campaign from the marketing campaign database 224. Thereafter, the second user of the user-computing device 106 (utilizing UI module 228) may send the updated marketing campaign to the second set of users through the GUI. In an embodiment, the UI module 228 may transmit the feedback to the keyword specification module 204 for updating the repository of the one or more first keywords.

In another embodiment, the second user (utilizing the UI module 228) may create a group of identified second set of users for the marketing campaign.

In operation, the social media platform server 102 may utilize the social media stream module 202 to analyze the social media stream. The social media stream may include the one or more messages posted/shared by one or more first users on one or more social media platforms. Prior to posting/sharing the one or more messages, the one or more first users may register on the one or more social media platforms. The one or more social media platforms such as, but not limited to, a social networking website, a chat/messaging application, a web-blog, web-forums, a community portal, an online community, or an online interest group. Further, each of the one or more first users, while registering onto the one or more social media platforms, may create a user profile. After registration, the one or more first users may post/share the one or more messages on the one or more social media platforms. Thereafter, the social media platform server 102 may extract the one or more messages. In an embodiment, the social media platform server 102 may employ one or more known extraction techniques to extract the one or more messages.

In an embodiment, the social media platform server 102 may store the one or more messages in the user database 208. In an embodiment, the one or more messages may include one or more types of messages such as, but not limited to, an audio message, a video message, or a text message. For example, if a message posted by a user on Facebook is “Hurray! India won the match”, then such type of message corresponds to a text message. In another scenario, if the message posted by the user is a lecture video, then such type of post may correspond to the video message. In an embodiment, the social media platform server 102 may store the user profile of the one or more first users in the user database 208.

Further, the application server 104 may utilize the keyword specification module 204 to retrieve the one or more first keywords from the one or more messages posted/shared by the one or more first users on the one or more social media platforms. In an embodiment, the application server 104 may further utilize the keyword specification module 204 to extract the one or more first keywords from the user profile of each of the one or more first users. In an embodiment, the one or more first keywords may indicate one or more events associated with the one or more first users. In an embodiment, the one or more events may be categorized into a first set of events, and a second set of events. In an embodiment, the first set of events may include events in the life of the one or more first users. On the other hand, the second set of events may include events in the life of the one or more third users (i.e., other user's life), acquainted with the one or more first users. For example, a message posted by a user on Facebook is “I am having my 18th birthday this weekend”. Further, based on the user's profile on the social media platform, the application server 104 may determine that the user's birthday falls on the forthcoming weekend, then the application server 104 may determine that the user was referring to his/her own birthday in the message. Thus, the event identified from the message (i.e., the birthday of the user) may correspond to the first set of events. In another scenario, a friend of the user comments on the earlier message posted by the user or simply shares the message with the same text, i.e., “I am having my 18th birthday this weekend”. In such a scenario, on analyzing the profile of the user's friend on the social media platform, the application server 104 may determine that the friend's birthday does not fall on the forthcoming weekend. Thus, the application server 104 may determine that the user's friend may not be referring to his/her own birthday in the message. Thus, the event identified from the message (i.e., the birthday of a person) may correspond to the second set of events. In another embodiment, the one or more first keywords may further indicate one or more intents of the one or more first users. In an embodiment, the one or more intents may correspond to intents of purchasing the one or more products/services. For example, a user showed an interest of buying a vehicle on a social networking website. In an embodiment, the application server 104 may employ one or more known extraction techniques to retrieve the one or more first keywords. In an embodiment, the keyword specification module 204 may store the one or more first keywords in the user database 208.

Further, the application server 104 may receive one or more second keywords, pertaining to a marketing campaign from the user-computing device 106 of the second user. In an embodiment, the second user may correspond to a retailer, a marketer, or a retail vendor. In an embodiment, the one or more second keywords may correspond to target events, or target intents. The target events may include events such as a marriage, a graduation, or a job, etc. On the other hand, the target intents may include intents such as whether a user wants to buy a vehicle (e.g., car, scooter, etc.). In an embodiment, the marketing campaign may correspond to an advertising marketing campaign, an organizational marketing campaign, or a political marketing campaign. A person having ordinary skill in the art will understand that the scope of the disclosure is not limited to the aforementioned marketing campaigns only.

Further, the application server 104 may utilize the filtering module 206 to identify the set of users from the one or more first users. Prior to identifying the set of users, the application server 104 may retrieve the one or more first keywords from the keyword specification module 204. Further, the application server 104 may receive the one or more second keywords from the second user of the user-computing device 106. Thereafter, the application server 104 may utilize the filtering module 206 to determine a correlation between the one or more first keywords and the one or more second keywords. Based on the correlation between the one or more first keywords and the one or more second keywords, the application server 104 (utilizing the filtering module 206) may identify keywords from the one or more first keywords. Further, based on the identified keywords, the application server 104 (utilizing the filtering module 206) may filter the set of users from the one or more first users. In an embodiment, the set of users may have utilized the identified keywords in the one or more messages posted/shared by them on the one or more social media platforms. In an embodiment, the application server 104 may utilize a keyword-based method to identify the set of users from the one or more first users. For example, the one or more second keywords may correspond to a marriage, a graduation, and a job. The application server 104 may identify those users from the one or more first users as the set of users, whose events (i.e., life events) correspond to the one or more second keywords (i.e., marriage, graduation, and job). In an embodiment, the application server 104 may store a list of the identified set of users in the user database 208.

A person having ordinary skill in the art will understand that the scope of the disclosure is not limited to using the keyword-based method for identifying the set of users. In an embodiment, the application server 104 may employ other methods, as well, to identify the set of users, without departing from the scope of the disclosure.

Post determining the identified set of users, the application server 104 may utilize the classification module 216 to classify the identified set of users in one or more sets of categories using one or more classifiers. In an embodiment, each of the one or more classifiers may be configured to classify the set of users in a set of categories from the one or more sets of categories. Prior to classifying the identified set of users, the application server 104 may train each of the one or more classifiers for a particular set of category from the one or more sets of categories. Thereafter, the application server 104 may utilize the classification module 216 to classify the identified set of users in the one or more sets of categories using the one or more classifiers. In an embodiment, the one or more sets of categories may include, but are not limited to, the demographic categories 216a, the one or more products/services owned/availed by the set of users category 216b, the rating provided by the set of users on the one or more products/services category 216c, the intent to purchase the one or more products or services category 216d, and the one or more events associated with each user in the set of users 216e. In an embodiment, the application server 104 may utilize classification-based technique to classify the identified set of users.

A person having ordinary skill in the art will understand that the scope of the disclosure is not limited to classifying the identified set of users using the classification-based technique. In an embodiment, the application server 104 may employ other techniques, as well, to classify the identified set of users, without departing from the scope of the disclosure.

Further, the application server 104 may utilize the scoring module 218 to determine a score for each of the one or more classifiers. In an embodiment, the score may indicate a confidence measure of each of the one or more classifiers in classifying the set of users in the one or more sets of categories. Prior determining the score, the application server 104 may receive the classified set of users from the classification module 216. Further, each of the one or more classifiers may be trained for a particular set of category from the one or more sets of categories. Thereafter, the application server 104 determines the score for each of the one or more classifiers. In an embodiment, the application server 104 may determine the score by using one or more regression techniques. The one or more regression techniques may include, but are not limited to, a logistic regression technique, or a ridge regression technique.

The application server 104 may further identify a second set of users from the set of users based at least on a set of rules defined for each of the one or more sets of categories, the score, and the second user's preferences. Prior to identifying the second set of users, the application server may extract the set of rules defined for each of the one or more sets of categories from the rule engine module 222. In an embodiment, the set of rules may be received from the user-computing device 106 of the second user. In an embodiment, the set of rules may correspond to demographics/group oriented rules, an event oriented rules, and an intent oriented rules. In another embodiment, the application server 104 may receive the preferences from the user-computing device 106 of the second user. The second user's preferences may include, but are not limited to, selecting a user from the second set of users for the marketing campaign, or selecting a set of categories from the one or more sets of categories for the marketing campaign. Thereafter, based on the second user's preferences, the score, and the set of rules, the application server 104 may identify a second set of users from the set of users. For example, if the second user provides a preference i.e. (selecting a user from the set of users for the marketing campaign), then the application server 104 may identify that user for the marketing campaign based on the second user's preferences.

In an embodiment, application server 104 may present the graphical user interface to the second user on the user-computing device 106. The graphical user interface may facilitate a display of a list of the second set of users to the second user. For example, if the identified second set of users are A, B, and C, then the application server 104 displays the list of the second set of users to the second user (i.e., A, B, and C). The graphical user interface (GUI) has been described later in conjunction with the FIGS. 5A, 5B, 5C, 5D, and 5E.

Further, the application server 104 may send the marketing campaign to computing devices of the identified second set of users. Prior to sending the marketing campaign, the application server 104 may extract the created marketing campaign (from the marketing campaign database 224). Thereafter, the application server 104 may send the marketing campaign. For example, if the application server 104 may identify second set of users based on an event such as “marriage,” then the marketing campaign may correspond to the marriage such as hotel booking, etc. In another scenario, if the application server 104 may identify the second set of users based on the determined score and the event such as job, then the application server 104 may send the marketing campaign pertaining to the job opportunities etc. to the computing devices of the identified set of users.

Further, the application server 104 may receive a feedback from the second set of users on the marketing campaign. The feedback may correspond to one or more actions performed by the second set of users on the marketing campaign. The one or more actions may include, but are not limited to, sharing the marketing campaign, commenting on the marketing campaign, liking/disliking the marketing campaign, posting content associated with the marketing campaign, uploading/downloading content associated with the marketing campaign, and so on. For example, if the marketing campaign corresponds to job opportunities, then a user from the second set of users may like the marketing campaign or may share the marketing campaign with other users on the social media platform. In another scenario, if the user dislikes or provides comments such as “provide job opportunities for freshers”. Further, the application server 104 may store the feedback in the marketing campaign database 224.

In an embodiment, the application server 104 may extract the updated marketing campaign from the marketing campaign database 224. In an embodiment, the marketing campaign is updated by the second user of the user-computing device 106 based on the feedback received from the second set of users. Further, the user-computing device 106 may store the updated marketing campaign in the marketing campaign database 224. Thereafter, the application server 104 extracts the updated marketing campaign. For example, as discussed above, based on the feedback received, the updated marketing campaign may correspond to the job opportunities for freshers.

FIG. 3 is a block diagram illustrating a system 300 for identifying a set of users for a marketing campaign, in accordance with at least one embodiment. For the purpose of the ongoing disclosure, the system 300 has been considered the application server 104. However, the scope of the disclosure should not be limited to the system 300 as the application server 104. The system 300 can also be realized as the user-computing device 106 without departing from the spirit of the disclosure.

The system 300 includes a microprocessor 302, an input device 304, a memory 306, a display device 308, a transceiver 310, an input terminal 312, and an output terminal 314. The microprocessor 302 is coupled to the input device 304, the memory 306, the display device 308, and the transceiver 310. The transceiver 310 may connect to the network 108 through the input terminal 312 and the output terminal 314.

The microprocessor 302 includes suitable logic, circuitry, and/or interfaces that are operable to execute one or more instructions stored in the memory 306 to perform predetermined operations. The microprocessor 302 may be implemented using one or more processor technologies known in the art. Examples of the microprocessor 302 include, but are not limited to, an x86 microprocessor, an ARM microprocessor, a Reduced Instruction Set Computing (RISC) microprocessor, an Application Specific Integrated Circuit (ASIC) microprocessor, a Complex Instruction Set Computing (CISC) microprocessor, or any other microprocessor.

The input device 304 may comprise suitable logic, circuitry, interfaces, and/or code that may be operable to receive a feedback from second set of users. As discussed above, the feedback may correspond to the one or more actions performed by the second set of users on the marketing campaign. In a scenario, where the system 300 corresponds to the user-computing device 106, the input device 304 may be a part of the user-computing device 106. Further, the input device 304 may receive the one or more second keywords from the second user. In an embodiment, the input device 304 may receive the second user's preferences. The input device 304 may be operable to communicate the input received from the second user to the microprocessor 302. Examples of the input devices may include, but are not limited to, a touch screen, a keyboard, a mouse, a joystick, a microphone, a camera, a motion sensor, a light sensor, and/or a docking station.

The memory 306 stores a set of instructions and data. Some of the commonly known memory implementations include, but are not limited to, a random access memory (RAM), a read only memory (ROM), a hard disk drive (HDD), and a secure digital (SD) card. Further, the memory 306 includes the one or more instructions that are executable by the microprocessor 302 to perform specific operations. It is apparent to a person with ordinary skills in the art that the one or more instructions stored in the memory 306 enable the hardware of the system 300 to perform the predetermined operations.

The display device 308 may comprise suitable logic, circuitry, interfaces, and/or code that may be operable to render a graphical user interface. In a scenario where the system 300 corresponds to the user-computing device 106, the display device 308 may be a part of the user-computing device 106. In an embodiment, the display device 308 may display a list of the second set of users to the second user of the user-computing device 106. In an embodiment, the display device 308 may be a touch screen that enables the second user to provide an input. In an embodiment, the touch screen may correspond to at least one of a resistive touch screen, capacitive touch screen, or a thermal touch screen. In an embodiment, the display device 308 may further receive the input through a virtual keypad, a stylus, a gesture, and/or a touch based input. In an embodiment, when the display device 308 has a touch screen, the display device 308 may receive the one or more second keywords from the second user of the user-computing device 106. Further, the display device 308 may receive feedback from the second set of users on the marketing campaign. In an embodiment, the display device 308 may be realized through several known technologies such as, but not limited to, Cathode Ray Tube (CRT) based display, Liquid Crystal Display (LCD), Light Emitting Diode (LED) based display, Organic LED display technology, and Retina display technology.

The transceiver 310 transmits and receives messages and data to/from various components of the system environment 100 (e.g., the social media platform server 102, and the user-computing device 106) over the network 108. In an embodiment, the transceiver 310 may receive the one or more second keywords pertaining to the marketing campaign and the second user's preferences from the user-computing device 106. The transceiver 310 may further receive a feedback of the second set of users on the marketing campaign from the computing devices of the second set of users. In an embodiment, the transceiver 310 is coupled to the input terminal 312 and the output terminal 314 through which the transceiver 310 may receive and transmit data/messages respectively. Examples of the input terminal 312 and the output terminal 314 include, but are not limited to, an antenna, an Ethernet port, a USB port, or any other port that can be configured to receive and transmit data. The transceiver 310 receives and transmits data/messages in accordance with the various communication protocols such as, TCP/IP, UDP, and 2G, 3G, or 4G communication protocols through the input terminal 312 and the output terminal 314, respectively.

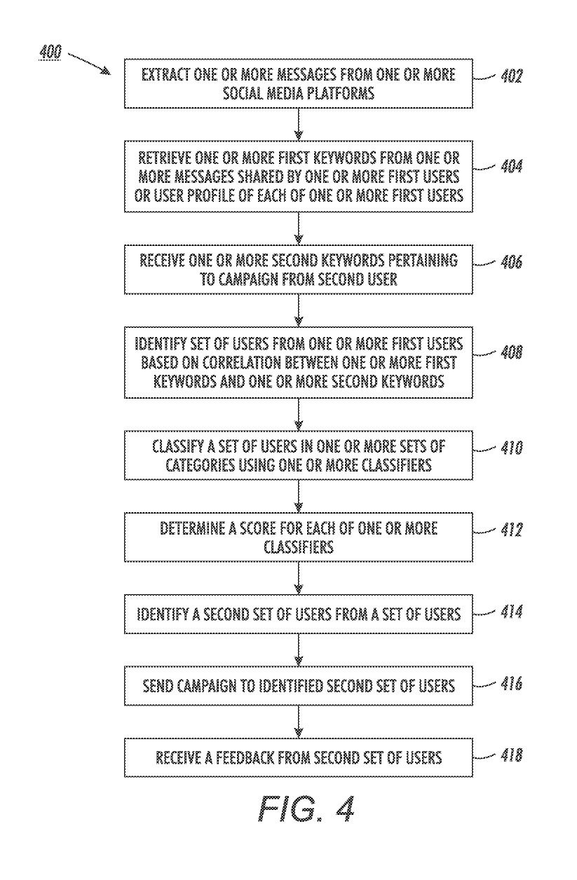

The operation of the system 300 has been described in conjunction with the FIG. 4.

FIG. 4 is a flowchart 400 illustrating a method for identifying a set of users for a marketing campaign, in accordance with at least one embodiment. The flowchart 400 has been described in conjunction with FIG. 1, FIG. 2A, FIG. 2B, and FIG. 3.

At step 402, one or more messages are extracted from one or more social media platforms. In an embodiment, the microprocessor 302 may extract the one or more messages from the one or more social media platforms. In an embodiment, the one or more messages may be related/shared/generated by the one or more first users on the one or more social media platforms, as discussed above. Prior to posting/sharing the one or more messages, the one or more first users may register on the one or more social media platforms. During registration, the one or more first users may share information such as, but not limited to, a location of a user, a gender of the user, a marital status of the user, an ethnicity of the user, a nationality of the user, a mother tongue of the user, an educational qualification of the user, a set of hobbies of the user, and an age of the user. Thereafter, the one or more first users may post/share the one or more messages on the one or more social media platforms. Thereafter, the microprocessor 302 may extract the one or more messages from the one or more social media platforms.

At step 404, one or more first keywords are retrieved. In an embodiment, the microprocessor 302 may retrieve the one or more first keywords from at least one of the one or more messages shared by the one or more first users on the one or more social media platforms, or from the user profile of each of the one or more first users. As discussed above, in an embodiment, the one or more first keywords may indicate the one or more events associated with the one or more first users, and the one or more intents of the one or more first users.

At step 406, one or more second keywords are received from a second user. In an embodiment, the microprocessor 302 may receive the one or more second keywords, pertaining to the marketing campaign from the second user. The microprocessor 302 may receive the one or more second keywords from the user-computing device 106 through the transceiver 310. In an embodiment, the one or more second keywords may correspond to target events, and target intents.

At step 408, a set of users is identified from the one or more first users. In an embodiment, the microprocessor 302 may identify the set of users from the one or more first users based on the correlation between the one or more first keywords and the one or more second keywords.

At step 410, the set of users is classified in one or more sets of categories. In an embodiment, the microprocessor 302 may classify the set of users in the one or more sets of categories using the one or more classifiers. In an embodiment, each of the one or more classifiers may be configured to classify the set of users in a set of categories from the one or more sets of categories.

At step 412, a score for each of the one or more classifiers is determined. In an embodiment, the microprocessor 302 may determine the score for each of the one or more classifiers using the one or more regression techniques.

At step 414, a second set of users is identified from the set of users. In an embodiment, the microprocessor 302 may identify the second set of users from the set of users based at least on the set of rules defined for each of the one or more sets of categories, the score, or the second user's preferences.

At step 416, a marketing campaign is sent to the identified second set of users. In an embodiment, the microprocessor 302 may send the marketing campaign to the identified second set of users.

At step 418, a feedback is received from the second set of users. In an embodiment, the microprocessor 302 may receive a feedback on the marketing campaign from the computing devices of the second set of users. The feedback may correspond to the one or more actions performed by the second set of users on the marketing campaign. The one or more actions may include, but are not limited to, sharing the marketing campaign, commenting on the marketing campaign, liking/disliking the marketing campaign, posting content associated with the marketing campaign, uploading/downloading content associated with the marketing campaign, and so on.

FIGS. 5A, 5B, 5C, 5D, and 5E, illustrate a graphical user interface 500 presented to a second user, in accordance with at least one embodiment. The graphical user interface 500 has been described in conjunction with FIG. 1, FIG. 2A, FIG. 2B, FIG. 3, and FIG. 4.

The graphical user interface, GUI, (depicted by 500) is presented to the second user on the user-computing device 106 of the second user. The GUI 500 may include a first GUI 502 (shown in FIG. 5A), a second GUI 504 (shown in FIG. 5B), a third GUI 506 (shown in FIG. 5C), a fourth GUI 508 (shown in FIG. 5D), and a fifth GUI 510 (shown in FIG. 5E). The first GUI (depicted by 502) may enable the second user to create a group of users from the second set of users. The second GUI (depicted by 504) may enable the second user to create the marketing campaign by specifying the one or more second keywords. Further, the third GUI (depicted by 506) may enable the second user to target the marketing campaign to the identified second set of users (i.e., the group of users, from the second set of users, selected by the second user). Further, the fourth GUI (depicted by 508) may enable the second user to select a sub category of events from the one or more events. The fourth GUI (depicted by 508) may include a region (depicted by 508a), which may enable the second user to categorize the one or more events into one or more sub categories. For example, the event “job” may include sub categories such as All, Employed, and None. Further, the fifth GUI (depicted by 510) may display posts of the one or more first users belonging to the sub category that was selected by the second user through the region 508a of the fourth GUI 508. The fifth GUI 510 may display the posts of such one or more first users within a box (depicted by 510a).

The disclosed embodiments encompass numerous advantages. Through various embodiments of the disclosure, a second set of users is identified for a marketing campaign. Further, it is disclosed that based on a correlation between the one or more first keywords and one or more second keywords (received from a second user); a set of users may be identified. Further, it is disclosed that the identified set of users may be classified in one or more sets of categories using one or more classifiers. Further, it is disclosed that a second set of users is identified based at least on a set of rules defined for each of the one or more sets of categories, a score, and second user's preferences. Thereafter, a marketing campaign is sent to the identified second set of users. Such a method to identify the second set of users may be more accurate as it is determined based at least on the set of rules defined for each of the one or more sets of categories, the score, and the second user's preferences. Organizations may benefit from such an identification technique as this may help them to identify their target users for the marketing campaign effectively.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks such as LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The systems and methods described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic.” Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above methods and systems, or the numerous possible variations thereof.

Various embodiments of the methods and systems for identifying a set of users for a marketing campaign have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art that are also intended to be encompassed by the following claims.

What is claimed is:

1. A method for identifying a set of users for a marketing campaign, said method comprising:
retrieving, by one or more microprocessors, one or more first keywords from one or more of one or more messages shared by one or more first users, or from a user profile of each of said one or more first users, wherein said one or more first keywords are indicative of one or more events associated with said one or more first users, and one or more intents of said one or more first users;
receiving, by said one or more microprocessors, one or more second keywords, pertaining to said marketing campaign, from a computing device of a second user; and
identifying, by said one or more microprocessors, said set of users from said one or more first users based on a correlation between said one or more first keywords and said one or more second keywords.

2. The method of claim 1 further comprising classifying, by said one or more microprocessors, said set of users in one or more sets of categories using one or more classifiers, wherein each of said one or more classifiers is configured to classify said set of users in a set of categories from said one or more sets of categories.

3. The method of claim 2, wherein said one or more sets of categories comprise demographic categories, one or more products/services owned/availed by said set of users, a rating provided by said set of users on said one or more products/services, one or more events associated with each user in said set of users, and an intent to purchase said one or more products or services.

4. The method of claim 2 further comprising determining, by said one or more microprocessors, a score for each of said one or more classifiers, wherein said score is indicative of a confidence measure of each of said one or more classifiers in classifying said set of users in said one or more sets of categories.

5. The method of claim 4 further comprising identifying, by said one or more microprocessors, a second set of users from said set of users based on one or more of a set of rules defined for each of said one or more sets of categories, said score, or said second user's preferences, wherein said set of rules is received from said computing device of said second user, and wherein said marketing campaign is sent to said second set of users.

6. The method of claim 5, wherein said second user's preferences comprise one or more of selecting a user from said second set of users for said marketing campaign, or selecting a set of categories from said one or more sets of categories for said marketing campaign.

7. The method of claim 5 further comprising displaying, on a display screen, a list of said second set of users through a graphical user interface to said second user.

8. The method of claim 5, wherein said marketing campaign is updated by said second user based on a feedback received from a computing device of said second set of users on said marketing campaign, wherein said feedback corresponds to one or more actions performed by said second set of users on said marketing campaign, and wherein said one or more actions performed by said second set of users comprise one or more of sharing said marketing campaign, commenting, liking/disliking, posting, or uploading/downloading.

9. The method of claim 1, wherein said one or more events comprise one or more of a first set of events, and a second set of events, wherein said first set of events comprises events involving said one or more first users, and wherein said second set of events comprises events involving one or more third users acquainted to said one or more first users on one or more social media platforms.

10. The method of claim 1, wherein said user profile of each of said one or more first users comprises information pertaining to a location of said user, a gender of said user, a marital status of said user, an ethnicity of said user, a nationality of said user, a mother tongue of said user, an educational qualification of said user, a set of hobbies of said user, or an age of said user.

11. The method of claim 1, wherein said second user corresponds to one or more of a retailer, a marketer, or a retail vendor.

12. The method of claim 1, wherein said marketing campaign comprises one or more of an advertising marketing campaign, an organizational marketing campaign, or a political marketing campaign.

13. A system for identifying a set of users for a marketing campaign, said system comprising:
one or more microprocessors configured to:
retrieve one or more first keywords from one or more of one or more messages shared by one or more first users, or from a user profile of each of said one or more first users, wherein said one or more first keywords are indicative of one or more events associated with said one or more first users, and one or more intents of said one or more first users;
receive one or more second keywords, pertaining to said marketing campaign, from a computing device of a second user; and
identify said set of users from said one or more first users based on a correlation between said one or more first keywords and said one or more second keywords.

14. The system of claim 13, wherein said one or more microprocessors are further configured to classify said set of users in one or more sets of categories using one or more classifiers, wherein each of said one or more classifiers is configured to classify said set of users in a set of categories from said one or more sets of categories.

15. The system of claim 14, wherein said one or more sets of categories comprise demographic categories, one or more products/services owned/availed by said set of users, rating provided by said set of users on said one or more products/services, one or more events associated with each user in said set of users, and an intent to purchase said one or more products or services.

16. The system of claim 14, wherein said one or more microprocessors are further configured to determine a score for each of said one or more classifiers, wherein said score is indicative of a confidence measure of each of said one or more classifiers in classifying said set of users in said one or more sets of categories.

17. The system of claim 16, wherein said one or more microprocessors are further configured to identify a second set of users from said set of users based on one or more of a set of rules defined for each of said one or more sets of categories, said score, or said second user's preferences, wherein said set of rules is received from said computing device of said second user, and wherein said marketing campaign is sent to said second set of users.

18. The system of claim 17, wherein said marketing campaign is updated by said second user based on a feedback received from a computing device of said second set of users on said marketing campaign, wherein said feedback corresponds to one or more actions performed by said second set of users on said marketing campaign, and wherein said one or more actions performed by said second set of users comprise one or more of sharing said marketing campaign, commenting, liking/disliking, posting, or uploading/downloading.

19. The system of claim 13, wherein said one or more events comprise one or more of a first set of events, and a second set of events, wherein said first set of events comprises events involving said one or more first users, wherein said second set of events comprises events involving one or more third users acquainted to said one or more first users on one or more social media platforms.

20. The system of claim 13, wherein said second user corresponds to one or more of a retailer, a marketer, or a retail vendor.

21. A computer program product for use with a computer, the computer program product comprising a non-transitory computer readable medium, wherein the non-transitory computer readable medium stores a computer program code for identifying a set of users for a marketing campaign, wherein the computer program code is executable by one or more processors to:
retrieve, by one or more microprocessors, one or more first keywords from one or more of one or more messages shared by one or more first users, or from a user profile of each of said one or more first users, wherein said one or more first keywords are indicative of one or more events associated with said one or more first users, and one or more intents of said one or more first users;
receive, by said one or more microprocessors, one or more second keywords, pertaining to said marketing campaign, from a computing device of a second user; and
identify, by said one or more microprocessors, said set of users from said one or more first users based on a correlation between said one or more first keywords and said one or more second keywords.
